(19) United States
(12) Patent Application Publication
(10) Pub. No.: US 2018/0129148 A1
(43) Pub. Date: May 10, 2018

(54) IMAGE FORMING APPARATUS, CONTROL METHOD THEREOF, AND STORAGE MEDIUM

(71) Applicant: CANON KABUSHIKI KAISHA, Tokyo (JP)

(72) Inventor: Kiwamu Suzuki, Kawasaki-shi (JP)

(21) Appl. No.: 15/793,203

(22) Filed: Oct. 25, 2017

(30) Foreign Application Priority Data
Nov. 10, 2016 (JP) 2016-219698

(51) Int. Cl. G03G 15/08

(52) U.S. Cl. CPC G03G 15/08; G03G 15/556; G03G 15/0834

(57) ABSTRACT

An image forming apparatus that performs printing on a printing medium by an electrophotographic method in accordance with input image data, including: a printing unit having at least: a development counter that forms a toner image on a photoconductor drum; and a plurality of supply members that store a predetermined amount of toner and supply toner to the development counter; and a control unit configured to control the printing unit, and the printing unit has a replenishment unit configured to replenish the plurality of supply members with toner, and an amount of toner with which each of the plurality of supply members is replenished is determined in accordance with a video count value indicating a density of the input image data, the video count value being corrected based on information on a printing position to be applied to the input image data.

### BACKGROUND OF THE INVENTION

### Field of the Invention

The present invention relates to an electrophotographic image forming apparatus and in detail, to a technique to measure a density value of an image data to be printing and to replenish a development counter with toner based on the measured value.

### Description of the Related Art

In copying and printing in an electrophotographic image forming apparatus, a toner image based on input image data is created by using toner (developer) and the toner image is fixed onto a printing sheet, and thus printing is performed. In a printer engine of an image forming apparatus that produces a printout by forming such a toner image, continuous printing processing is implemented by sequentially replenishing a hopper (having a role to store toner and to supply toner to a development counter) with toner corresponding to the amount that is consumed for toner image formation. Then, for replenishment of toner, a method called an in-page video count is used. This is a method of replenishing each of a plurality of hoppers with toner by acquiring a video count value (density value) of a formed image in units of pages and equally dividing the toner consumption corresponding to one page, which is calculated from the video count value, by the number of hoppers. However, in the case of this method, a hopper that has consumed toner more than the found average value is not replenished with a sufficient amount of toner, and in the case where such a situation is repeated, a problem of unevenness in density and the like will occur because part of the hoppers run short of toner. Further, with a variety of factors added, such as an increase in the speed of an image forming apparatus, a reduction in capacity of a hopper, and an increase in the conveyance speed of toner, the problem caused by the above-described method has begun to surface. Consequently, in order to improve replenishment accuracy of toner, a method called an in-page block-division video count has been proposed, which acquires the video count value in units of blocks obtained by dividing a page in the main scanning direction and in the sub scanning direction (see Japanese Patent Laid-Open No. 2012-128317). Specifically, this is a technique to control the amount of toner to be replenished and the replenishment timing for each hopper based on the video count value measured in units of blocks. Due to this, it is possible to accurately replenish each hopper with toner corresponding to the consumption.

However, there is a case where adjustment to shift the printing position of an image because of several factors at the time of performing printing by the image forming apparatus. There are two main factors that make adjustment of the printing position necessary. The first factor is a change in the printing position due to the characteristics of a sheet. In the electrophotographic method, an image is fixed onto a sheet by causing the sheet onto which toner is transferred to pass through a fixing unit after development. Because the sheet passes through the fixing unit at a high temperature, the sheet expands or contracts and there is a case where the printing position of the image shifts, and therefore, such a shift is adjusted. The degree of expansion/contraction of a sheet differs depending on the basis weight, surface properties, size, and so on of the sheet, and therefore, adjustment is made for each sheet. The second factor is a change in the printing position, which results from the physical structure, such as the sheet feed cassette and the conveyance system. For example, there is a case where it is necessary to shift the timing to find the top of the printing position or to perform modification in accordance with the inclination of a sheet because of the structure. Further, the degree of the printing position adjustment caused by the above-described reasons is not constant due to deterioration over time. Because of this, many electrophotographic image forming apparatuses include a function to adjust the printing position.

Here, at the time of determining the amount of toner to be replenished by the in-page video count technique, including the method of Japanese Patent Laid-Open No. 2012-128317, unless the above-described adjustment of the printing position is taken into consideration, there is a case where the video count value based on image data and the position of a hopper that has actually consumed toner do not coincide with each other. For example, there may be a case where the image portion of the video count value indicating a large toner consumption is not formed actually on the sheet by the adjustment of the printing position. In this case, it is not possible to appropriately replenish toner in accordance with the consumption, and therefore, the above-described problem of unevenness in density may occur.

### SUMMARY OF THE INVENTION

The image forming apparatus according to the present invention is an image forming apparatus that performs printing on a printing medium by an electrophotographic method in accordance with input image data, including: a printing unit having at least: a development counter that forms a toner image on a photoconductor drum; and a plurality of supply members that store a predetermined amount of toner and supply toner to the development counter; and a control unit configured to control the printing unit, and the printing unit has a replenishment unit configured to replenish the plurality of supply members with toner, and an amount of toner with which each of the plurality of supply members is replenished is determined in accordance with a video count value indicating a density of the input image data, the video count value being corrected based on information on a printing position to be applied to the input image data.

Further features of the present invention will become apparent from the following description of exemplary embodiments with reference to the attached drawings.

### BRIEF DESCRIPTION OF THE DRAWINGS

FIG. 1 is a diagram showing an example of a hardware configuration of an image forming apparatus;

FIG. 2 is a flowchart showing a flow of printing processing in the image forming apparatus;

FIG. 3 is a diagram explaining the way toner is replenished based on a video count value;

FIG. 4 is a diagram showing an example of the video count value in units of blocks;

FIG. 5 is a diagram showing the way hoppers are replenished with toner;

FIG. 6 is a flowchart showing a flow of video count value acquisition processing;

FIG. 7A and FIG. 7B are diagrams showing states where coordinates are allocated to blocks;

FIG. 8 is a diagram showing a position relationship between printing positions before and after being shifted;

FIG. 9A and FIG. 9B are diagrams explaining a calculation of a video count value that takes shift into consideration;

FIG. 10A and FIG. 10B are diagrams explaining a calculation of the video count value that takes shift into consideration; and

FIG. 11 is a diagram showing video count values after a recalculation of all the blocks.

### DESCRIPTION OF THE EMBODIMENTS

### First Embodiment

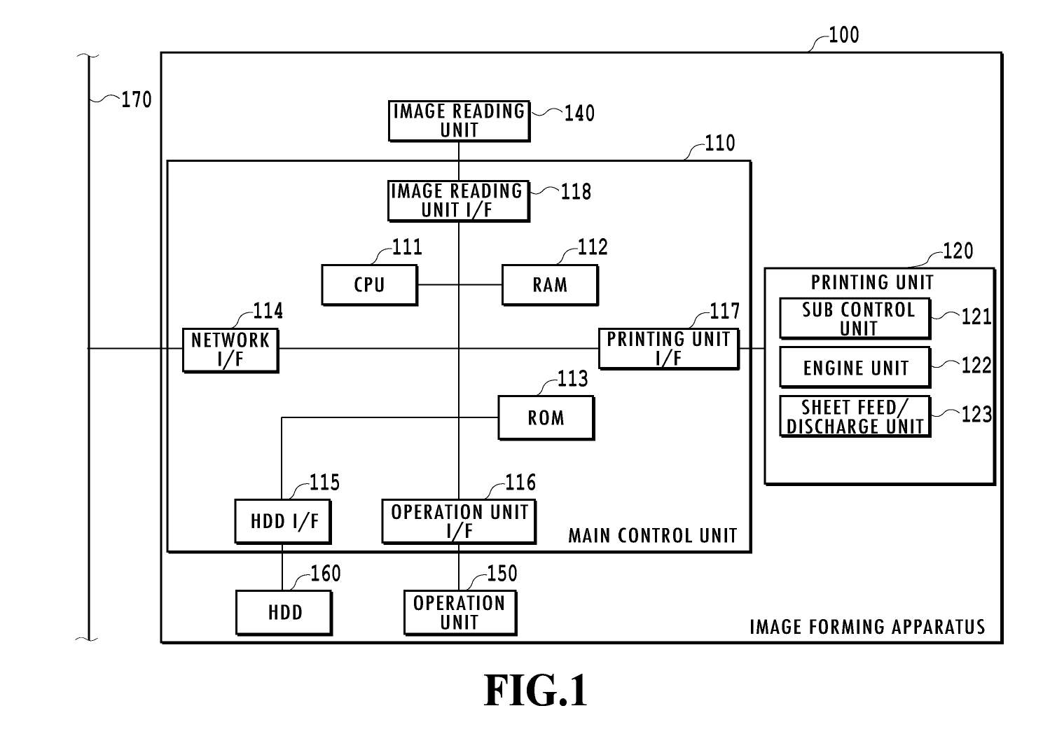

FIG. 1 is a diagram showing an example of a hardware configuration of an image forming apparatus according to the present embodiment. An image forming apparatus 100 includes a main control unit 110, a printing unit 120, an image reading unit 140, an operation unit 150, and an HDD 160. The main control unit 110 further includes a CPU 111, a RAM 112, a ROM 113, a network I/F 114, an HDD I/F 115, an operation unit I/F 116, a printing unit I/F 117, and an image reading unit I/F 118 and each unit is connected to one another via an internal bus. To the image forming apparatus 100, a client PC, not shown schematically, is connected via a network 170, such as a LAN, so that both are capable of communication with each other. The image forming apparatus 100 of the present embodiment is a printer that performs image formation (printing) on a printing medium, such as paper, by the electrophotographic method. However, the image forming apparatus 100 may be a multi function printer (MFP) that installs a plurality of functions, such as the copy function, the scan function, and the FAX function, not only the print function. The network I/F 114 performs transmission and reception of data with an external device, such as the client PC, not shown schematically, via the network 170. For example, in the case where a user gives printing instructions by using the printer driver within the client PC, a print job generated based on the instructions is transmitted to the image forming apparatus 100 via the network 170. The image forming apparatus 100 performs processing to form an image on a printing medium, such as paper, based on the received print job.

The CPU 111 is an arithmetic processing unit that centralizedly controls the operation of each unit of the image forming apparatus 100. The image reading unit 140 includes a light source and an image sensor and generates image data by optically reading a document arranged on a document table while scanning the document. The operation unit 150 includes a display unit, such as an LCD display, and an operation reception unit provided with a hardware key and the like. The display unit displays a user interface screen on which to perform settings of various functions of the image forming apparatus 100, a job processing situation, and so on. The operation reception unit includes keys to receive various instructions from a user, a power source button, and LEDs to indicate a job processing situation and a power supply state, such as a power-saving mode. There is also a case where instructions from a user are received by a software key displayed on the display unit. The operation unit I/F 116 performs processing to generate display data to be displayed on the operation unit 150 and to display the data on the display unit. The ROM 113 and the HDD 160 store basic programs and control programs, setting values, tables, and so on, which are necessary for the operation of the image forming apparatus 100. For example, the CPU 111 implements various operations by reading programs stored in the ROM 113 or the HDD 160 onto the RAM 112 and executing the programs. The HDD I/F 115 is an interface with the HDD 160 and controls write and read of data to and from the HDD 160.

The printing unit 120 includes a sub control unit 121, an engine unit 122, and a sheet feed/discharge unit 123. The sub control unit 121 includes a CPU and a memory and controls the operation of the engine unit 122 in cooperation with or independently of the main control unit 110 via the printing unit I/F 117. The sheet feed/discharge unit 122 feeds a printing medium (hereinafter, “sheet”), such as paper, to the engine unit 122 and discharges a sheet for which printing processing has been completed. The engine unit 122 includes a photoconductor drum, a laser exposure device, a development counter, a fixing unit, and so on to implement an electrophotographic process including each process of electrification, exposure, development, transfer, and fixing. The development counter is a mechanism in charge of development process and includes a sleeve as a toner carrier and a blade as a toner restricting member and forms a toner image by attaching toner to a latent image formed on the photoconductor drum. The toner consumed in the development counter is supplied at all times from a hopper (toner supply member) capable of storing a predetermined amount of toner to the development counter. The toner within the hopper is replenished from a toner storage unit, such as a toner bottle and a toner cartridge. Consequently, in order to perform printing processing without any delay, it is necessary to replenish the hopper with an appropriate amount of toner at appropriate timing.

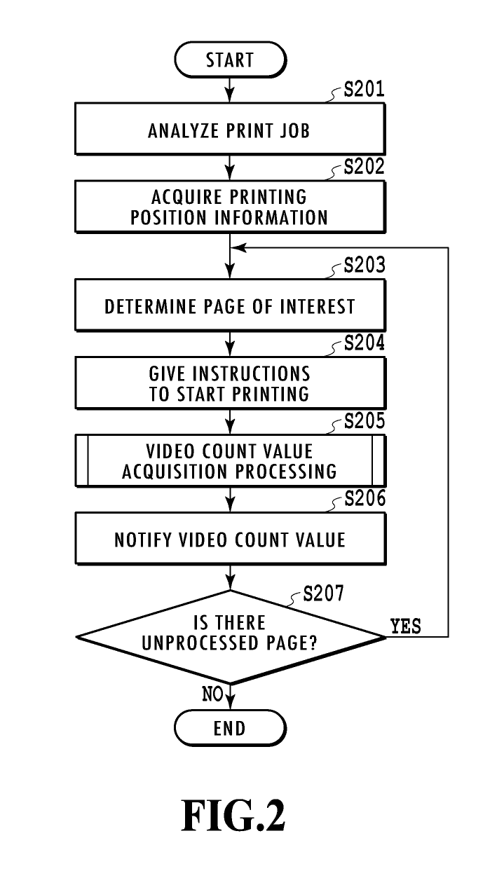

FIG. 2 is a flowchart showing a flow of printing processing in the image forming apparatus 100. Each step below is implemented by the CPU 111 within the main control unit 110 loading a predetermined application program onto the RAM 112 and executing the program. In the case where a user gives instruction to perform printing from the printer driver of the client PC and a print job is received via the network 170 and the network I/F 114, this flow is started. The print job includes, in addition to image data (PDL data) that is a target of printing processing, various kinds of setting information necessary for printing processing, for example, such as sheet feed source information indicating the source of a fed sheet to be used and a sheet information indicating the size and type of a sheet to be used.

At step 201, the received print job is analyzed. Specifically, image data (print image data) that can be processed by the printing unit 120 is generated by performing predetermined image processing, such as rendering processing and halftone processing. Further, information on the sheet cassette to be used, the type of a sheet to be used, and the page number for which printing processing is to be performed is acquired.

At step 202 that follows, information on the printing position at the time of performing printing processing of input image data is acquired. In the case where printing processing is performed at a position shifted in the main scanning direction and/or in the sub scanning direction from a reference printing position (default position), the printing position information includes information indicating how much and in which direction the printing position is shifted. In the case where printing processing is performed at the default position, the information will be information indicating no adjustment of printing position (amount of shift=0). The main scanning direction is a direction in which a laser ray scans on the photoconductor drum and the sub scanning direction is a direction perpendicular to the main scanning direction (direction in which a sheet is conveyed). In this case, the amount of shift at the time of adjustment of the printing position includes that which is manually set by a user and that which is set by the sub control unit 121 within the printing unit 120 automatically making adjustment. In the case where the amount of shift is set manually by a user, test printing is performed by specifying the sheet cassette and the type of a sheet which are adjustment-target via a dedicated UI screen (not shown schematically) that is displayed on the operation unit 150 and a desired numerical value is input by determining how much the printing position is shifted based on the output results. In this manner, for example, printing position information in which the sheet cassette, the sheet type, and the amount of shift are associated with one another is set as follows and stored in the HDD 160 and the like.

sheet feed source: cassette 1

sheet type: A4 size, thick sheet

amount of shift: +10 mm in the main scanning direction, −10 mm in the sub scanning direction

At step 203, based on the information on the page number acquired by the job analysis at step 201, the printing processing-target page (page of interest) is determined. In the stage immediately after the processing starts, the first page is determined to be the page of interest and after this, the page of interest is sequentially updated in the ascending order from the second page up to the last page. Then, at step 204, to the printing unit 120, instructions to start printing are sent along with the print mage data of the page of interest. Upon receipt of the instructions, in the printing unit 120, under the control of the sub control unit 121, a sheet is fed to the engine unit 122 from the specified sheet cassette within the sheet feed/discharge unit 123 and an image in accordance with the print image data is formed on the sheet.

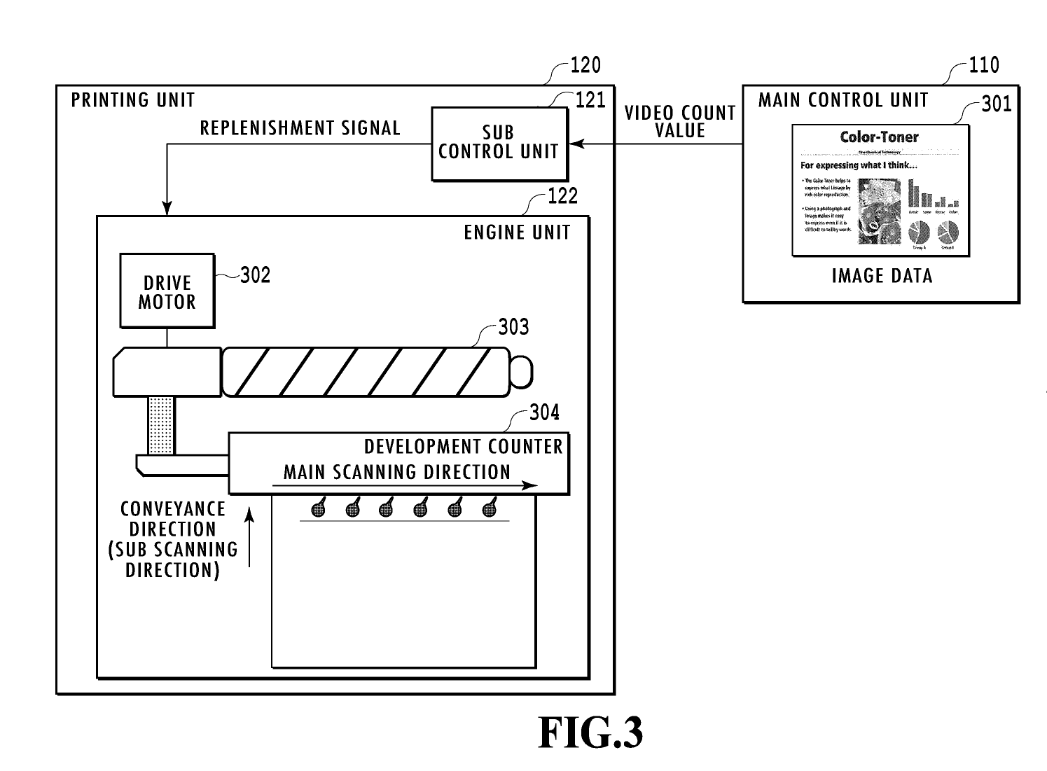

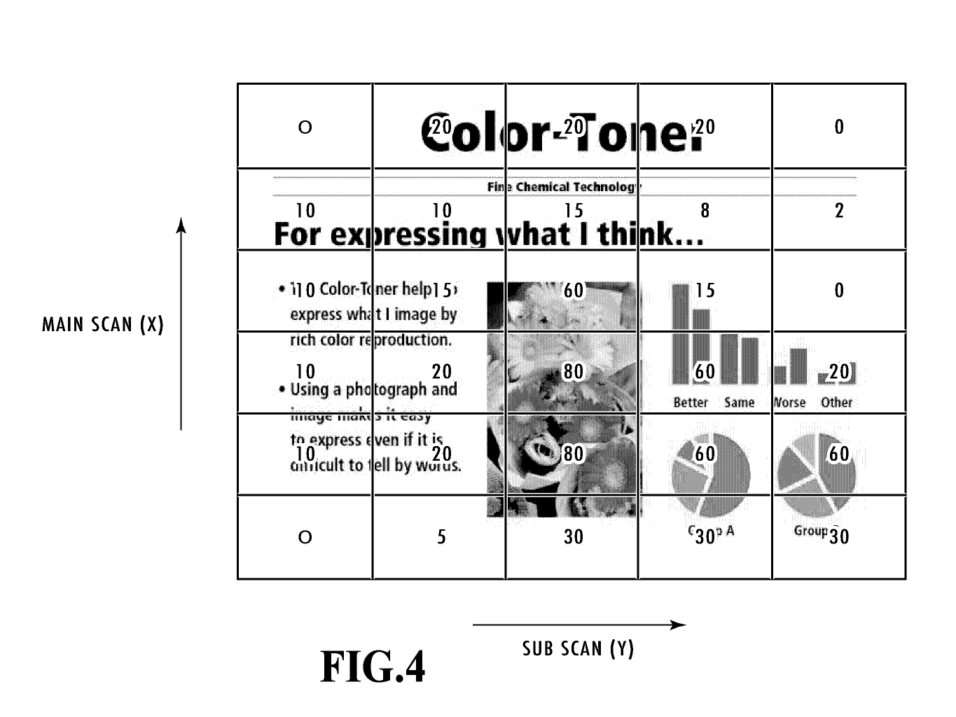

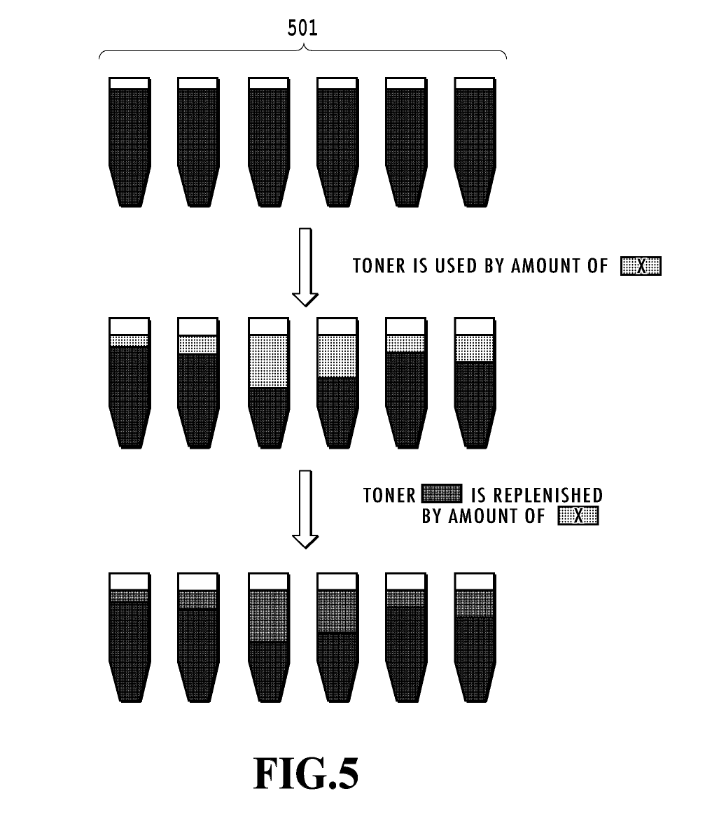

At step 205, processing to acquire a video count value is performed. In the present embodiment, by the in-page block-division video count method described previously, the video count value in units of blocks is acquired. Then, at step 206, the printing unit 120 is notified of the acquired video count value in units of blocks. Upon receipt of the notification, in the engine unit 122 of the printing unit 120, in preparation for the printing processing of the next page, the hopper is replenished with toner corresponding to the consumption. FIG. 3 is a diagram explaining the way toner is replenished based on the notified video count value. First, the main control unit 110 acquires the video count value in units of blocks from generated print image data 301 and notifies the printing unit 120 of the video count value. FIG. 4 shows the video count value in units of blocks, which is acquired from the print image data 301. In the example in FIG. 4, one page is divided into thirty blocks in total by dividing the page into six blocks in the main scanning direction and into five blocks in the sub scanning direction, and for each block, a video count value between “2” and “80” is obtained. Then, by the sub control unit 121 within the printing unit 120, a replenishment signal in accordance with the received video count value is sent to the engine unit 122. A drive motor 302 within the engine unit 122 replenishes a hopper (not shown schematically), which is a toner supply member, with a predetermined amount of toner from a toner storage 303 based on the received replenishment signal. FIG. 5 is diagram showing the way hoppers are replenished with toner. A plurality of hoppers 501 shown in FIG. 5 is provided side by side in one row along the main scanning direction (in the present embodiment, the number of hoppers is six that is the same as the number of divisions on the main scan side in the above-described blocks). In FIG. 5, the upper row shows a state of the hoppers 501 before printing is started and a sufficient amount of toner is stored in each hopper. The middle row shows a state of the hoppers 501 at the point in time of completion of printing processing of one page, and the amounts of toner that is consumed are different for different hoppers. Then, the lower row shows a state where the consumed toner is replenished and the hoppers 501 are replenished with different amounts of toner and the state becomes again the same as the state in the upper row. At this time, which hopper is to be replenished with how much toner is determined based on the video count value in units of blocks, which is notified by the main control unit 110. The video count value in units of blocks shown in FIG. 4 corresponds to the reference printing position (default position), and therefore, unless there is a shift in the printing position, toner is replenished accurately. As described above, based on the video count value, each of the plurality of hoppers is replenished with an amount of toner corresponding to the actual consumption. In this case, it may also be possible to replenish each hopper by dividing the replenishment into a plurality of times (for example, corresponding to the number of divisions on the sub scan side of the blocks). However, in the case where the actual printing position in the engine unit 122 is shifted from the default position, the replenishment lacks accuracy. Consequently, in the present embodiment, based on the printing position information at the time of printing processing to be applied to input image data, the video count value that takes into consideration the amount of shift from the default position is recalculated. Details of the acquisition processing of the video count value according to the present embodiment will be described later.

At step 207, whether the printing processing has been completed for all the pages of the input image data is determined. In the case where there is an unprocessed page, the processing returns to step 203 and the next page is taken to be the page of interest and the processing is continued. On the other hand, in the case where there is no unprocessed page, the present processing is terminated.

The above is the rough flow of the printing processing in the image forming apparatus 100. Although omitted in the flow in FIG. 2, in the case where printing of a plurality of copies is specified in the print job, the above-described flow is repeated the number of times corresponding to the specified number of copies.

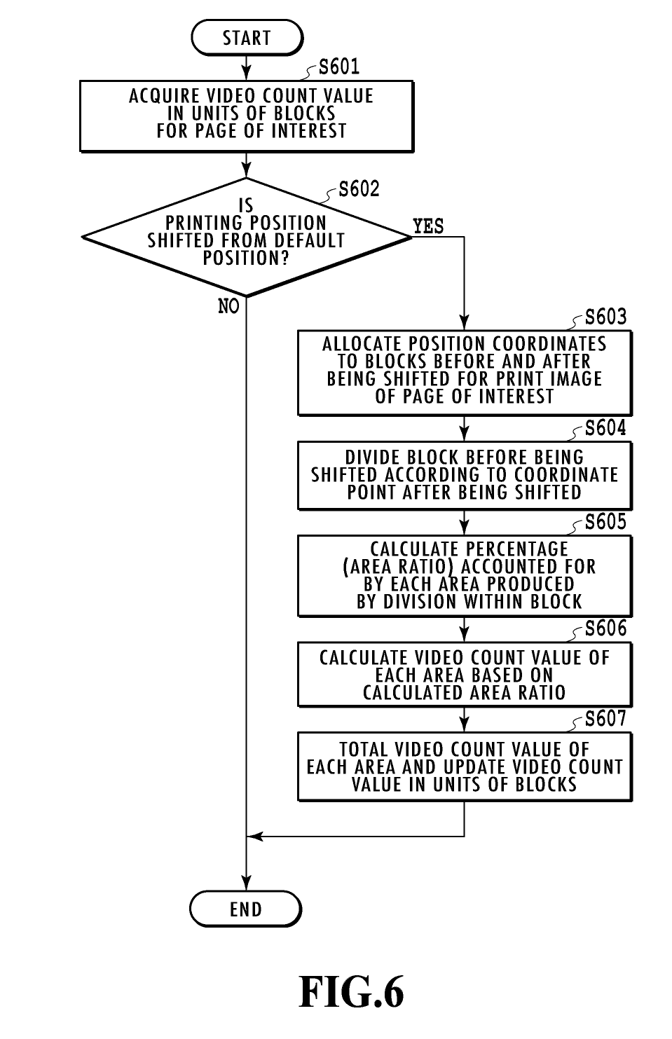

Following the above, the video count value acquisition processing at step 205 described above, which is the feature of the present embodiment, is explained in detail. FIG. 6 is a flowchart showing details of the video count value acquisition processing. In the case where the engine unit 122 is compatible with full-color printing, for example, the following flow is performed for each color plane of CMYK.

At step 601, based on the image data that can be processed by the printing unit 120, which is generated by the job analysis at step 201 described previously, the video count value for the page of interest is acquired in units of blocks. Specifically, by a counter, not shown schematically, for each block obtained by dividing the image data of the page of interest into a predetermined number of blocks (here, thirty blocks in total by dividing into six blocks in the main scanning direction and into five blocks in the sub scanning direction), pixel values (density values) within the block are accumulated. The value between “2” and “80” described previously is the value obtained by converting the accumulated value in units of blocks obtained as described above into the toner consumption and the maximum value thereof is “100”. The video count value in units of blocks, which is acquired at this step, is stored in the RAM 112.

At step 602 that follows, based on the printing position information acquired at step 202 described previously, whether or not there is a deviation (shift) from the default position is determined. For example, in the case where a value other than “0” is set as the amount of shift in the main scanning direction or in the sub scanning direction, the results of the determination indicate that “there is a shift”, and in the case where “0” is set as the amount of shift, the results of the determination indicate that “there is no shift”. In the case where the results of the determination indicate that “there is no shift”, the present processing is exited. On the other hand, in the case of “there is a shift”, the processing advances to step 603.

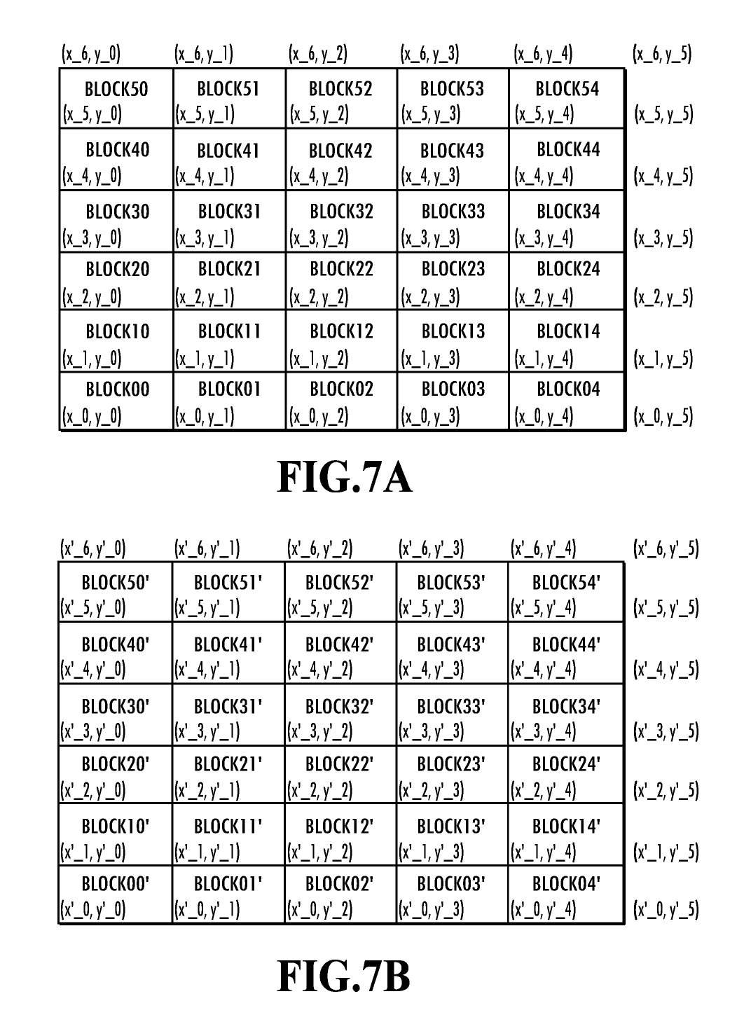

At step 603, for the printing-target image of the page of interest, coordinates to specify the position of each block before being shifted and after being shifted, respectively, are allocated. That is, the coordinates of the position of each block at the default position and the coordinates of the position of each block after the printing position is shifted by the amount of shift specified in the printing position information are determined. In the example in FIG. 4 described previously, for each block obtained by dividing the page into six (n=6) blocks in the main scanning (x) direction and into five (m=5) blocks in the sub scanning (y) direction, the coordinates to specify the position of each block before being shifted and after being shifted, respectively, are allocated. First, to the blocks at the default position before being shifted, coordinates of (x_0, y_0) to (x_6, y_5) are allocated. FIG. 7A is a diagram showing a state where the coordinates are allocated to the blocks before being shifted. The actual coordinates are found by scan length×index/number of divisions of coordinates. For example, in the case where an A4-size (210 mm×297 mm) sheet is divided into six blocks in the main scanning direction and into five blocks in the sub scanning direction, the coordinate points of the main scan and the sub scan are as follows.

<Coordinates in Main Scanning Direction>

210×1/6=35, 210×2/6=70, 210×3/6=105, 210×4/6=140, 210×5/6=175, 210×6/6=210

<Coordinates in Sub Scanning Direction>

297×1/5=59.4, 297×2/5=118.8, 297×3/5=178.2, 297×4/5=237.6, 297×5/5=297

Consequently, the actual coordinate points will be as follows.

(x_0,y_0)=(0,0), (x_1,y_0)=(35,0), (x_2,y_0)=(70, 0), (x_3,y_0)=(105,0), (x_4,y_0)=(140,0), (x_5,y_0)=(175,0), (x_6,y_0)=(210,0)

(x_0,y_1)=(0,59.4), (x_1,y_1)=(35,59.4), (x_2,y_1)=(70,59.4), (x_3,y_1)=(105,59.4), (x_4,y_1)=(140,59.4), (x_5,y_1)=(175,59.4), (x_6,y_1)=(210,59.4)

(x_0,y_2)=(0,118.8), (x_1,y_2)=(35,118.8), (x_2,y_2)=(70,118.8), (x_3,y_2)=(105,118.8), (x_4,y_2)=(140,118.8), (x_5,y_2)=(175,118.8), (x_6,y_2)=(210,118.8)

(x_0,y_3)=(0,178.2), (x_1,y_3)=(35,178.2), (x_2,y_3)=(70,178.2), (x_3,y_3)=(105,178.2), (x_4,y_3)=(140,178.2), (x_5,y_3)=(175,178.2), (x_6,y_3)=(210,178.2) (x_0,y_4)=(0,237.6), (x_1,y_4)=(35,237.6), (x_2,y_4)=(70,237.6), (x_3,y_4)=(105,237.6), (x_4,y_{—}4)=(140,237.6), (x_5,y_4)=(175,237.6), (x_6,y_4)=(210,237.6) (x_0,y_5)=(0,297), (x_1,y_5)=(35,297), (x_2,y_5)=(70,297), (x_3,y_5)=(105,297), (x_4,y_5)=(140,297), (x_5,y_5)=(175,297), (x_6,y_5)=(210,297)

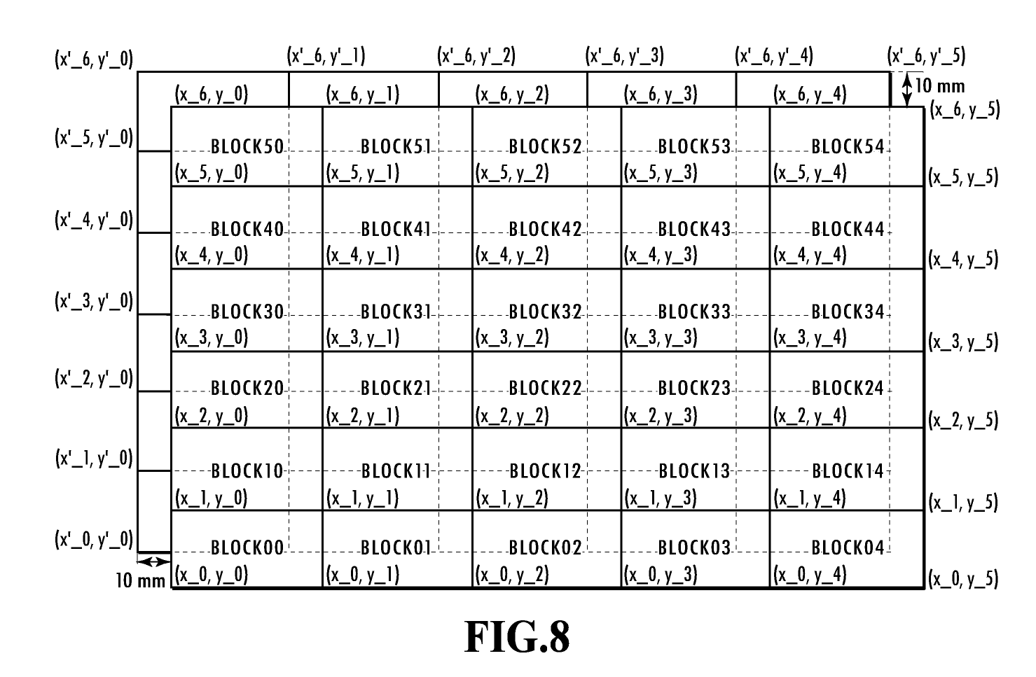

Similarly to the above, for the blocks after being shifted, coordinates of (x′_0, y′_0) to (x′_6, y′_5) are —allocated. FIG. 7B is a diagram showing a state where the coordinates are allocated to each block after being shifted. Then, FIG. 8 is a diagram showing a position relationship between printing positions before and after being shifted. It is known that the corresponding blocks are shifted from each other by the amount of shift (+10 mm in the main scanning direction and −10 mm in the sub scanning direction) specified in the printing position information.

On completion of allocation of coordinates, where in the block before being shifted, each of the coordinate points (x′_0, y′_0) to (x′_6, y′_5) after being shifted is located is determined. Specifically, where in the area surrounded by four coordinate points (x_n, y_m), (x_(n+1), y_m), (x_n, y_(m+1)), and (x_(n+1), y_(m+1)) in the block before being shifted, each coordinate position is located is determined. Here, to the coordinate point after being shifted, which is not located in any block, an identifier indicating that the coordinate point is not located in any block is attached. After where in the block before being shifted, each coordinate point is located is found for all the coordinate points after being shifted, the processing advances to step 604.

At step 604, according to the coordinate point after being shifted, the block before being shifted is divided into four blocks. Each area within the block divided into four areas according to the coordinate point after being shifted is taken to be “area A”, “area B”, “area C”, and “area D”.

At step 605, the percentage (area ratio) accounted for by each of the four areas in each block is found. The area ratio of an area is found by dividing the area of each area by the area of the block and each is expressed by each expression below.

area ratio of area A=area of area A/area of block

area ratio of area B=area of area B/area of block

area ratio of area C=area of area C/area of block

area ratio of area D=area of area D/area of block

In the expressions described above, the area of each area and the area of the block are expressed by each expression below.

area of area A=(x_(n+1)−x′_n)×(y′_m−y_m)

area of area B=(x_(n+1)−x′_n)×(y_(m+1)−y′_m)

area of area C=(x′_n−x_n)×(y′_m−y_m)

area of area D=(aj−x_n)×(y_(m+1)−y′_m)

area of block=(x(n+1)−x_n)×(y_(m+1)−y_m)

At step 606, the video count value of each area for each block is calculated based on the area ratio of each area, which is found at step 605. The video count value of each area is found by dividing the area ratio of each area by the video count value of the block including the area, and the video count value is expressed by each expression below.

video count value of area A=area ratio of area A×video count value of block including area A

video count value of area B=area ratio of area B×video count value of block including area B

video count value of area C=area ratio of area C×video count value of block including area C

video count value of area D=area ratio of area D×video count value of block including area D

At step 607, the video count values of area A to area D, which are calculated at step 606, are totaled for each block and the totaled value is determined to be a new video count value in each block. The data of the totaled value for each block, which is thus obtained, is overwritten to the RAM 112 as the video count value in units of blocks, which reflects shift of the printing position. In this manner, the data of the video count value in units of blocks, which is acquired and stored at step 201, is updated to the above-described recalculated value.

The above is the contents of the video count value acquisition processing according to the present embodiment. In the following, explanation is given by using a specific example. Here, the video count value that takes into consideration the shift of the printing position in the case where the image data shown in FIG. 4 is printed on an A4-size sheet is recalculated. It is assumed that the amount of shift in this case is +10 mm in the main scanning direction and −10 mm in the sub scanning direction. The image data shown in FIG. 4 is divided into six blocks in the main scanning direction and into five blocks in the sub scanning direction, and therefore, the size of each block is 35 mm×59.4 mm.

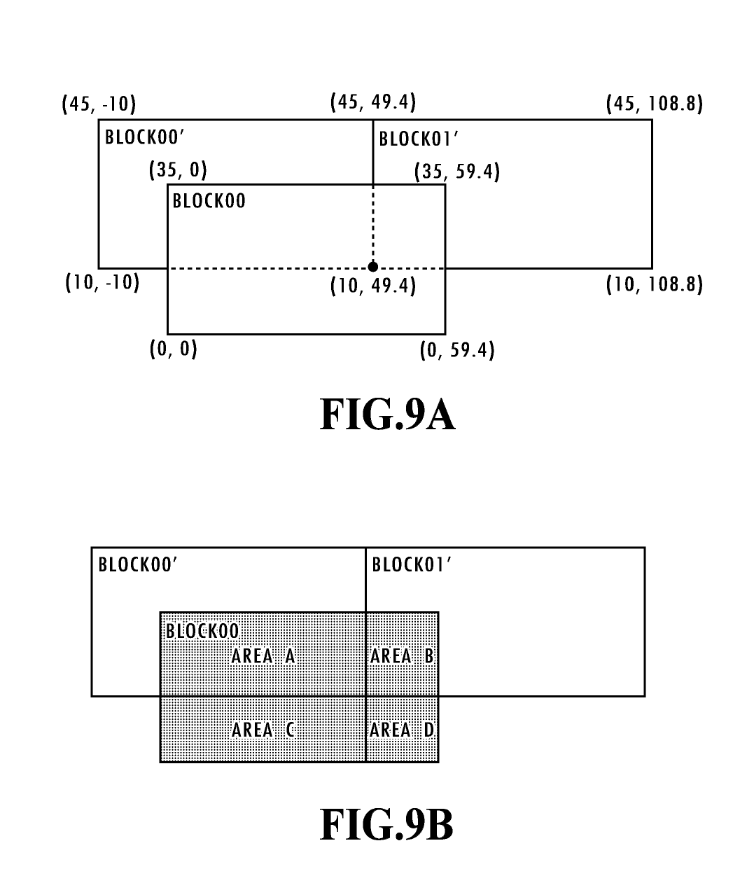

First, the calculation of the video count value that takes deviation (shift) into consideration for the block (here, block 00 in the bottom-left corner) at the image end portion is explained. FIG. 9A is a diagram showing a position relationship between the block 00 before being shifted and two blocks (block 00′ and block 01′) after being shifted, which overlap the block 00. In this case, four coordinates of the block 00 are (0, 0), (35, 0), (35, 59.4), and (0, 59.4). Consequently, the coordinate point after being shifted, whose main scan is included in “0 to 35” and whose sub scan is included in “0 to 59.4”, is (10, 49.4), that is, (x′_0, y′_1). FIG. 9B shows a state where the block 00 before being shifted is divided into four areas (area A to area D) according to the coordinate point (x′_0, y′_1)=(10, 49.4). The areas of each area and the block and the area ratio of each area are found from expressions described previously as follows.

area of area A=(x_(n+1)−x′_n)×(y′_m−y_m)=(35−10)×(49.4−0)=1235

area of area B=(x_(n+1)−x′_n)×(y_(m+1)−y′_m)=(35−10)×(59.4−49.4)=250

area of area C=0 (no corresponding block)

area of area D=0 (no corresponding block)

area of block=(x_1−x_0)×(y_1−y_0)=(59.4−0)×(45−0)=2079

area ratio of area A=1235/2079≈0.60

area ratio of area B=250/2079≈0.12

area ratio of area C=0/2079=0

area ratio of area D=0/2079=0

Then, the obtained area ratio of each area is multiplied by the video count value of the block to which each area belongs and the value obtained by totaling the video count values of all the areas is taken to be the video count value of the block 00 that takes shift into consideration. In the case of the present specific example, the video count value of each area is

video count value of area A=0.60×0=0,

video count value of area B=0.12×5=0.60,

video count value of area C=0×0, and

video count value of area D=0×0, respectively,

and the video count value of the block 00 that takes shift into consideration is 0+0.60+0+0=0.60.

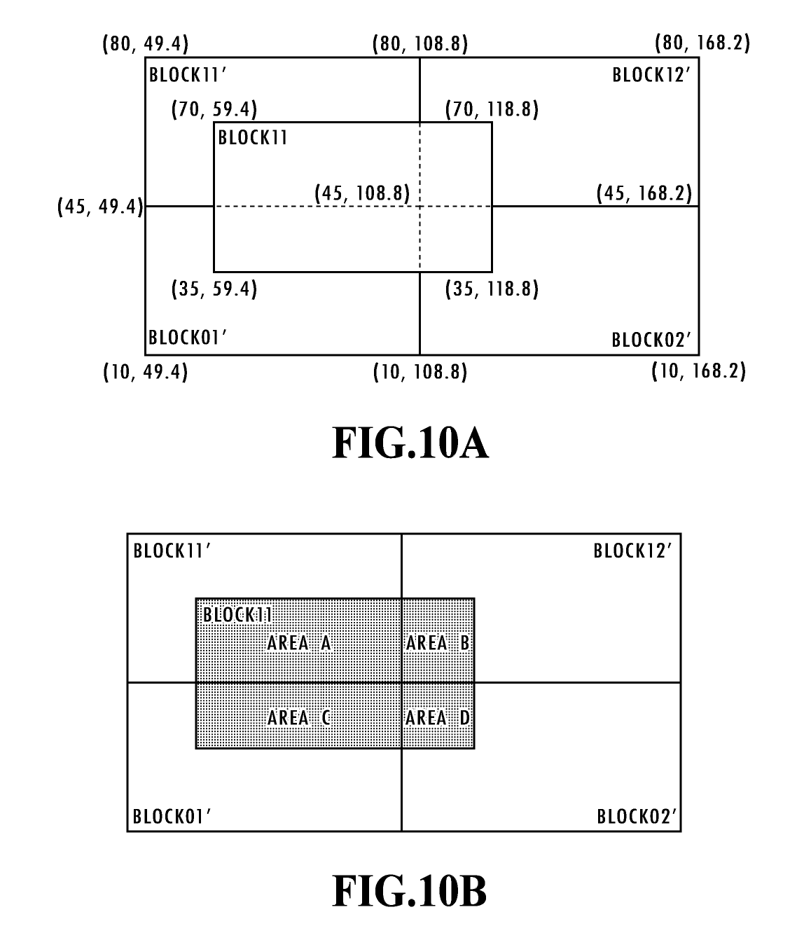

Next, the calculation of the video count value that takes deviation (shift) into consideration for the block (here, block 11) inside the image is explained. FIG. 10A is a diagram showing a position relationship between the block 11 before being shifted and four blocks (block 01′, block 02′, block 11′, block 12′) after being shifted, which overlap the block 11. In this case, four coordinates of the block 11 are (35, 59.4), (70, 59.4), (70, 118.8), and (35, 118.8). Consequently, the coordinate point whose main scan is included in “35 to 70” and whose sub scan is included in “59.4 to 118.8” is (45, 108.8), that is, (x′_1, y′_2). FIG. 10B shows a state where the block 11 before being shifted is divided into four areas (area A to area D) according to the coordinate point (x′_1, y′_2)=(45, 108.8). The areas of each area and the block and the area ratio of each area are found from the expressions described previously as follows.

area of area A=(x_2−x′1)×(y′_2−y_1)=(70−45)×(108.8−59.4)=1235

area of area B=(x_2−x′_1)×(y_2−y′_2)=(70−45)×(118.8−108.8)=250

area of area C=(x′_1−x_1)×(y′_2−y_1)=(45−35)×(108.8−59.4)=494

area of area D=(x_2−a2)×(b1−y1)=(45−35)×(118.8−108.8)=100

Here, the area of the block is 2079, and therefore, the area ratio of each area is as follows.

area ratio of area A=1235/2079≈0.60

area ratio of area B=250/2079≈0.12

area ratio of area C=494/2079≈0.24

area ratio of area D=100/2079≈0.05

Then, the obtained area ratio of each area is multiplied by the video count value of the block to which each area belongs and the value obtained by totaling the video count values of all the areas is taken to be the video count value of the block 11 that takes shift into consideration. In the case of the present specific example, the video count value of each area is

video count value of area A=0.60×20=12.0,

video count value of area B=0.12×80=9.6,

video count value of area C=0.24×5=1.2, and

video count value of area D=0.05×30=1.5, respectively,

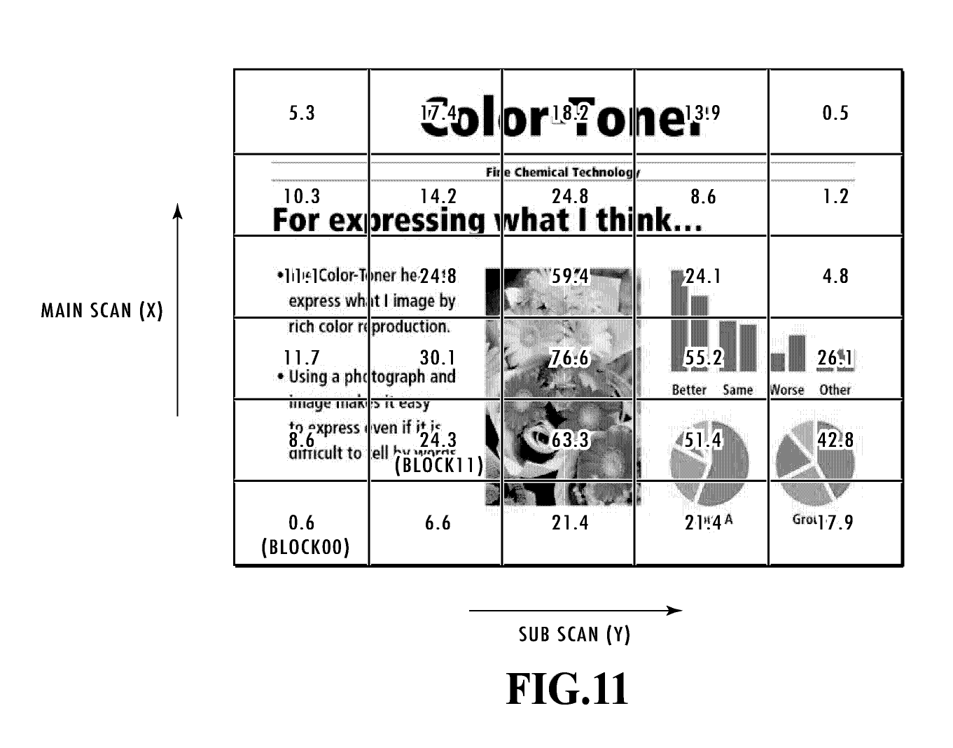

and the video count value of the block 11 that takes shift into consideration is 12.0+9.6+1.2+1.5=24.3. By performing the processing such as this for all the blocks, the accurate video count value that takes into consideration the amount of shift of the printing position is obtained. FIG. 11 is a diagram showing the recalculated video count values of all the blocks. By a comparison with FIG. 4, it is known that each recalculated value becomes a value corrected by the amount of shift of the printing position+10 mm in the main scanning direction and −10 mm in the sub scanning direction. By notifying the printing unit 120 of the video count value thus corrected, it is made possible for each hopper to be replenished with an appropriate amount of toner, which takes into consideration the toner consumption at the actual printing position.

In the present embodiment, explanation is given by taking the in-page block-division video count as an example, in which the video count value is acquired in units of blocks by dividing the inside of a page into a plurality of blocks. However, it is possible to similarly apply the present embodiment to the case where the video count value is acquired in units of pages without dividing the page into a plurality of blocks. Further, in the present embodiment, the video count value that reflects the shift of the printing position is recalculated on the side of the main control unit 110 and the printing unit 120 is notified of the recalculated video count value, and thereby, replenishment of an appropriate amount of toner is implemented on the side of the printing unit 120 based on the video count value. However, it may also be possible for the side of the main control unit 110 to notify the printing unit 120 of the video count value as it is, which does not reflect the shift of the printing position, and for the side of the printing unit 120 to determine the amount of toner to be replenished after recalculating the video count value that reflects shift. That is, it may also be possible to design a configuration in which each piece of the processing at step 603 to step 607 in the flow in FIG. 6 described previously is performed by the sub control unit 121 within the printing unit 120. What is required is to make it possible to determine, in the case where the printing position in the engine unit 122 changes from the default position, an amount of toner with which the hopper is replenished in accordance with the amount of the change (amount of shift).

As above, according to the present embodiment, in an electrophotographic image forming apparatus, in the case where the printing position is adjusted, it is possible to replenish a hopper with an appropriate amount of toner, which takes into consideration the adjustment contents. Due to this, it is possible to prevent a problem, such as unevenness in density, from arising in the printing results.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, in an electrophotographic image forming apparatus, it is possible to replenish toner in accordance with the actual consumption by taking into consideration adjustment contents of the printing position. Due to this, it is possible to prevent unevenness in density from occurring in the printing results.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-219698 filed Nov. 10, 2016, which is hereby incorporated by reference wherein in its entirety.

What is claimed is:

1. An image forming apparatus that performs printing on a printing medium by an electrophotographic method in accordance with input image data, comprising:
a printing unit having at least:
a development counter that forms a toner image on a photoconductor drum; and
a plurality of supply members that store a predetermined amount of toner and supply toner to the development counter; and
a control unit configured to control the printing unit, wherein
the printing unit has a replenishment unit configured to replenish the plurality of supply members with toner, and
an amount of toner with which each of the plurality of supply members is replenished is determined in accordance with a video count value indicating a density of the input image data, the video count value being corrected based on information on a printing position to be applied to the input image data.

2. The image forming apparatus according to claim 1, wherein
the information on a printing position includes an amount of shift in a main scanning direction and in a sub scanning direction from a reference printing position.

3. The image forming apparatus according to claim 2, wherein
the information on a printing position further includes a type of the printing medium.

4. The image forming apparatus according to claim 3, further comprising:
a setting unit configured to set the information on a printing position by at least associating the amount of shift and a type of the printing medium with each other.

5. The image forming apparatus according to claim 1, wherein
the control unit notifies the printing unit of the video count value corresponding to the reference printing position after correcting the video count value based on the information on a printing position, and
the replenishment unit determines an amount of toner with which the plurality of supply members is replenished based on the corrected video count value.

6. The image forming apparatus according to claim 5, wherein
the control unit acquires the video count value corresponding to the reference printing position in units of blocks by which a page is divided and corrects the video count value in units of blocks based on the information on a printing position, and
the replenishment unit determines an amount of toner with which each of the plurality of supply members is replenished based on the corrected video count value in units of blocks.

7. The image forming apparatus according to claim 6, wherein
the correction is processing to find a new video count value in units of blocks by:
allocating coordinates to blocks before and after being shifted based on an amount of shift specified in the information on a printing position for each page of the input image data;
dividing a block before being shifted according to a coordinate point after being shifted;
calculating an area ratio within the block of each area produced by division; and
calculating a video count value of each of the areas based on the calculated area ratio and totaling the video count values.

8. The image forming apparatus according to claim 6, wherein
a number of supply members is the same as a number of divisions in a main scanning direction of a block by which a page is divided.

9. The image forming apparatus according to claim 1, wherein
the replenishment unit acquires the information on a printing position, corrects a video count value corresponding to the reference printing position notified by the control unit based on the information on a printing position, and determines an amount of toner with which the plurality of supply members is replenished based on the corrected video count value.

10. The image forming apparatus according to claim 9, wherein
the control unit acquires the video count value corresponding to the reference printing position in units of blocks by which a page is divided and notifies the printing unit of the video count value, and
the replenishment unit corrects the video count value corresponding to the notified reference printing position based on the information on a printing position and determines an amount of toner with which the plurality of supply members is replenished based on the corrected video count value.

11. The image forming apparatus according to claim 10, wherein
the correction is processing to find a new video count value in units of blocks by:
allocating coordinates to blocks before and after being shifted based on an amount of shift specified in the information on a printing position for each page of the input image data;
dividing a block before being shifted according to a coordinate point after being shifted;
calculating an area ratio within the block of each area produced by division; and
calculating a video count value of each of the areas based on the calculated area ratio and totaling the video count values.

12. The image forming apparatus according to claim 10, wherein
a number of supply members is the same as a number of divisions in a main scanning direction of a block by which a page is divided.

13. A control method of an image forming apparatus that performs printing on a printing medium by an electrophotographic method in accordance with input image data, the image forming apparatus including:
a printing unit having at least:
a development counter that forms a toner image on a photoconductor drum; and
a plurality of supply members that store a predetermined amount of toner and supply toner to the development counter; and
a control unit configured to control the printing unit, the control method comprising:
a determination step of determining an amount of toner with which each of the plurality of supply members is replenished based on a video count value indicating a density of the input image data, the video count value being corrected based on information on a printing position to be applied to the input image data; and
a replenishment step of replenishing the plurality of supply members with the amount of toner determined at the determination step.

14. A non-transitory computer readable storage medium storing a program for causing a computer to perform a control method of an image forming apparatus that performs printing on a printing medium by an electrophotographic method in accordance with input image data, the image forming apparatus including:
a printing unit having at least:
a development counter that forms a toner image on a photoconductor drum; and
a plurality of supply members that store a predetermined amount of toner and supply toner to the development counter; and
a control unit configured to control the printing unit, the control method comprising:
a determination step of determining an amount of toner with which each of the plurality of supply members is replenished based on a video count value indicating a density of the input image data, the video count value being corrected based on information on a printing position to be applied to the input image data; and
a replenishment step of replenishing the plurality of supply members with the amount of toner determined at the determination step.
